(19) United States
(12) Patent Application Publication
(10) Pub. No.: US 2011/0282757 A1
(43) Pub. Date: Nov. 17, 2011

(54) System and Method for Online Design and Ordering of Architectural Millwork

(76) Inventors: Robert E. Muckle, JR., Wolcott, CT (US); Scott F. Summa, Wolcott, CT (US)

(21) Appl. No.: 12/968,260

(22) Filed: Dec. 14, 2010

Related U.S. Application Data
(60) Provisional application No. 61/286,373, filed on Dec. 14, 2009.

(51) Int. Cl. G06Q 30/00

(52) U.S. Cl. 705/26.5; 705/26.8

(57) ABSTRACT

A method and system for the online design, real-time visual rendering, ordering, and manufacturing of various architectural millwork products such as wainscoting panels, cabinet doors, fireplace mantels, and columns. A user logs on to a system server over the Internet using a personal computer and common browser, chooses one of many configurable designs, inputs dimensional and critical build criteria, receives a real-time image displayed on his computer screen from such input, receives further real-time images with each user selectable change to such inputs, so as to render immediate visual images of the as-designed product on the user's computer screen. After the user submits his final order through an online-cart and check out process, the order is further reviewed by a backend system and thereafter processed for generating CNC machine code and other related manufacturing instructions to further automate the manufacturing process.

### CROSS REFERENCES TO RELATED APPLICATIONS

This non-provisional patent application claims a priority benefit to U.S. Provisional Application No. 61,286,373 entitled “System and Method for Online Design and Ordering of Architectural Millwork” filed in the United States Patent and Trademark Office on Dec. 14, 2009 by a common Inventor to this instant application, Robert E. Muckle. Further the above named Provisional Application in its entirety is hereby incorporated by reference.

### STATEMENT REGARDING FEDERALLY SPONSORED RESEARCH

Not Applicable

### REFERENCE TO APPENDIX

Not Applicable

### BACKGROUND OF THE INVENTION

Frame and panel construction (also called “rail and stile”) is a woodworking technique often used in the making of doors, wainscoting, and other decorative features for cabinets, furniture, and homes. The basic idea is to capture a ‘floating’ panel within a sturdy frame, as opposed to techniques used in making a slab solid wood cabinet door or drawer front, the door is constructed of several solid wood pieces running in a vertical or horizontal direction with exposed end grains. Usually, the panel is not glued to the frame, it is left to ‘float’ within it so that seasonal movement of the wood comprising the panel does not distort the frame.

Frame and panel construction at its most basic consists of five members: the panel and the four members which make up the frame. The vertical members of the frame are called stiles while the horizontal members are known as rails. A basic frame and panel item consists of a top rail, a bottom rail, two stiles, and a panel. This is a common method of constructing cabinet doors and these are often referred to as a five piece door.

In larger panels it is common to divide the panel into one or more sections. To house the extra panels, dividing pieces known as mid rails and mid stiles or muntins are added to the frame.

### FIELD OF THE INVENTION

The System and Method for Online Design and Ordering of Architectural Millwork provides a unique solution by producing real time architectural product design images displayed in an intuitive user interface. This solution radically simplifies the complexities of custom architectural millwork, allowing customers to design and place orders without professional assistance.

This system guides customers through the design process as they view their creation and enter design parameters such as size, shape, material type, color, texture among other design characteristics. The images provide real time design feedback giving the customer the ability to explore input options and optimize the design in a timely fashion, which is just not feasible with other design and order methods. The system documents the design criteria with drawings that are displayed immediately on screen and in the customer cart. The order transaction is completed when the integrated payment system applies shipping charges and applicable sales taxes to the order and either charges the customers PayPal/credit card or bills the customer. The order and all design features are captured in the system's database. These product design characteristics are also leveraged for programming the CNC equipment and for manufacturing instructions.

What makes this design, order and programming system unique and a valuable solution to a well known problem is that it minimizes the complexities of designing and ordering custom architectural millwork. The system provides customers with a simple step by step process that they can use without the assistance of a design professional.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a flow chart of the high level customer process;

FIGS. 2A-2N are front elevation drawings of several examples of architectural millwork products;

FIG. 3 is a computer screen shot showing how the invention calculates the computer screen drawing coordinates of a product;

FIG. 4A is a table showing preferred dimensions for stile widths and rail heights;

FIGS. 4B-4D are front elevation drawings of varying sized panels;

FIGS. 5A-5C are front elevation drawings of panels with a varying number of inner panels;

FIG. 6A is a computer screen shot displaying a typical error message to a user;

FIG. 6B is a computer screen shot displaying another typical message to a user;

FIGS. 7A-7C are front elevation views of several panels being dynamically scaled to accommodate a varying number of inner panels;

FIGS. 8A-8C are Excel scatter plot product images of staircase panels;

FIG. 9A is a front elevation view of a panel showing shading techniques to achieve a three-dimensional effect;

FIGS. 9B-9C are front elevation views of panels showing the use of a shading fill technique to achieve a three-dimensional effect;

FIG. 10 is a computer screen shot of the invention showing a user design interface;

FIG. 11 is a computer screen shot of the invention showing the checkout cart;

FIG. 12 is a computer screen shot of the invention showing the checkout and payment process;

FIGS. 13A-13C are computer screen shots showing various business interface views;

FIG. 14 is a computer screen shot showing the CNC programming coordinates for the automatic manufacture of a particular panel;

FIG. 15A is a front elevation view of a particular panel for manufacture;

FIG. 15B is a table with calculated coordinates for CNC control;

FIG. 15C is machine code generated from the table in FIG. 15B for CNC machine control;

FIG. 16A is a computer screen shot of the user interface showing additional design features selectable by the user;

FIG. 16B is a front elevation view of panels selected and designed by the user;

FIG. 17A is a computer screen shot showing user design choices for panels adaptable to staircase design;

FIG. 17B is a perspective drawing showing staircase measurements;

FIG. 18A is a computer screen shot showing a user design interface with choices for full wall panel design;

FIG. 18B is a front elevation view of stacked panels for surrounding a window or other framed object;

FIG. 19 is a computer screen shot showing the design dimensions and criteria required for an arched panel design;

FIG. 20 is a computer screen shot showing the design dimensions and criteria required for a pediment head and pilasters system;

FIG. 21A is a front elevation drawing of a cabinet door/drawer fronts with dimensional criteria;

FIG. 21B is a cross-sectional drawing of the cabinet door in FIG. 21A showing details of the hinge and alignment with the cabinet frame;

FIG. 22 is a computer screen shot showing the user interface for selecting one of various columns designs and dimensions thereof;

FIG. 23 is a computer screen shot showing the user interface for selecting one of various fireplace mantel as designs and dimensions thereof; and

FIG. 24 is a computer screen shot showing the user interface for selecting one of various cabinet face frame designs and dimensions thereof.

### DETAILED DESCRIPTION OF THE EMBODIMENT

The basic steps of our invention are:

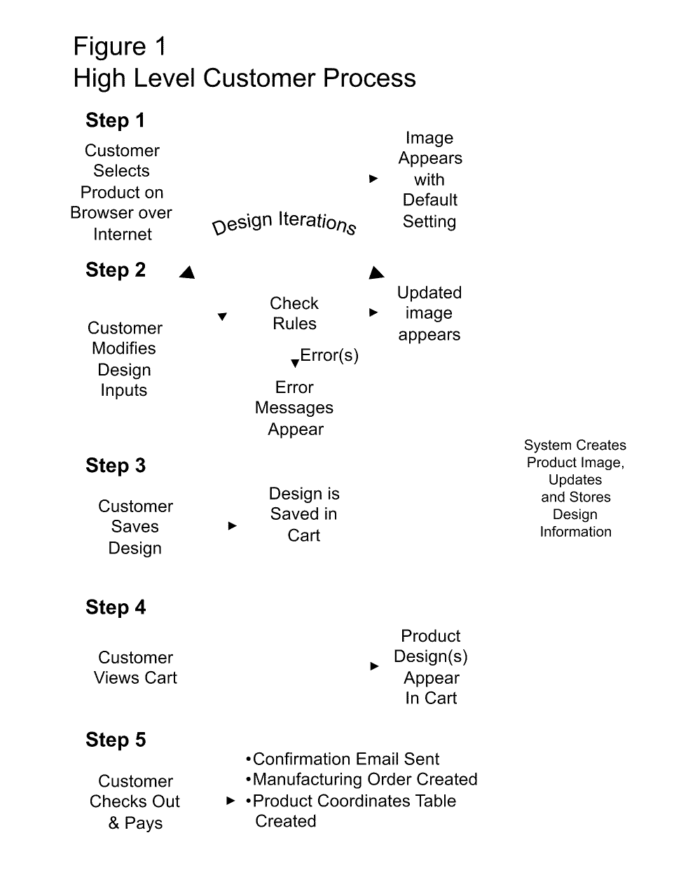

### High Level Process—FIG. 1

Step 1. Customer Selects Product
Product attributes are calculated using default inputs
Image of product appears in user interface

Step 2. Customer modifies inputs as desired (Length, Height, etc.)
System applies product rules to new inputs and updates image in real time
Iterative process. Customer can continue to change input fields as necessary

Step 3. Customer saves product design
Product is saved to cart/architectural drawings produced
An order is created and saved in the database

Step 4. Customer views cart, checks out to purchase products
Payment is processed
Product is saved to cart/architectural drawings produced.
Email of cart/architectural drawings are sent to the customer and to the manufacturer to process the products.

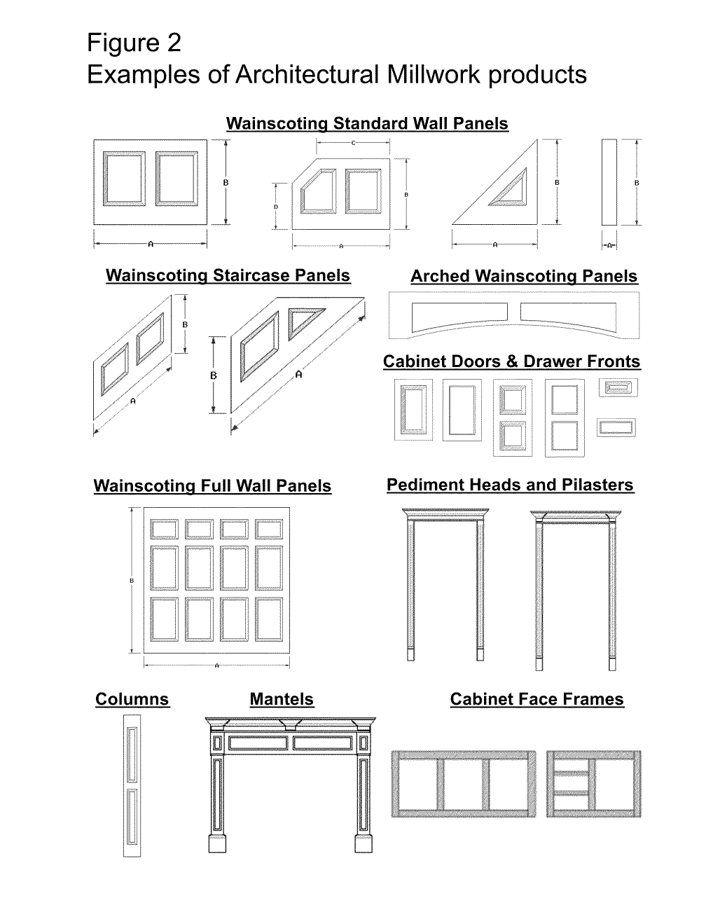

### Products—FIG. 2

The system capability is broad in that many products can be defined and programmed. The current products that are programmed include;

Wainscoting Standard, Staircase, Arched and Wall Panels

Pediment Head with Pilaster millwork for window and doors

Cabinet Doors and Drawer Fronts

Columns

Fireplace Mantels

Cabinet Face Frames

### System Elements Include;

Product Knowledge Programs
Product characteristics and rules that include geometric attributes
Dynamic Defaults, Error Checking and Dynamic Scaling
Product Design Images rendered in real time in User Interface
Database of tables

Intuitive User Interface
Design Interface
Cart with Architectural Specifications
Check Out and Payment Process

CNC Programming Information and Coordinates

### Product Knowledge Programs

### Geometric Characteristics

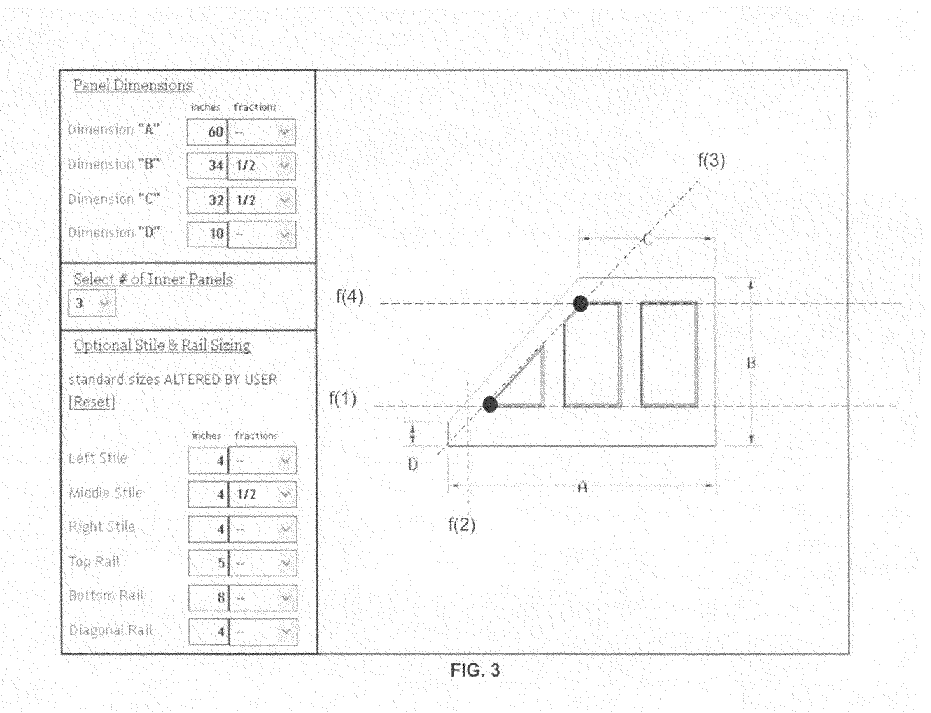

Each product has geometric characteristics that are defined mathematically. These geometric characteristics along with product rules and user inputs are used to generate a product image that will be presented in the user interface.
The images are constructed from geometric objects such as lines, arcs, circles, polygons, etc. Each geometric object is dynamic in that its coordinates, size and orientation are calculated every time an input is changed.
Manufacturing parameter rules are also defined for items such as minimum lengths, maximum lengths, tooling sizes, tooling clearances, material lengths, heights, thicknesses, etc.
The product image is totally flexible in that it can be programmed as a two dimensional view or as any number of pictorial techniques that will best illustrate a 3 dimensional view in a 2 dimensional image.
Conventional algebraic and geometry techniques are leveraged extensively in the product image calculations. Some of the techniques include;
   Mathematically calculates the location of the product image attributes. One example is solving for x and y intercepts of functions to calculate key intersection points. Refer to the FIG. 3 for a Wainscoting example;
      The system calculates the boundaries of the inner panels relative to the outside panel edges, the length and height of the inner panels and the location of the inner panel nodes.
      The locations of the inner panel are solved by finding the intercepts of F(1), F(2), F(3) and F(4). Note that the lower left point of the triangle inner panel starts at the F(1) and F(3) intercept and not at the F(1) and F(2) intercept. The user set the left stile input to 4 inches but the system over rides this F(2) user input because the F(1) and F(3) intercept takes precedents.
   2×2 matrix transforms (ax+cy, bx+dy) can change the size and orientation of the image by controlling the a, b, c and d variables.
Architectural dimensions, dimensional lines and arrows are all geometrically defined and will adjust with the product sizing. Refer to the “A”, “B”, “C” and “D” dimensioning in FIG. 3 as an example.

In FIG. 3, the user inputs his desired dimensions on the left side of the computer screen for various dimensions such as A, B, C, and D. The user also selects the number of inner panels. He can also adjust the dimensions of the stiles and rails. As soon as the user completes any dimensional change the figure on the right side of the computer screen is updated almost instantly in accordance with the new input. This gives the user a very valuable tool, immediate visual rendering of the designed product. A user can very quickly manipulate various dimensions and product parameters to identify an aesthetic product that is pleasing to him. The invention calculates in real-time all of the screen coordinates necessary to draw the image in accordance with the inputs selected by the user from the left-hand side of the screen.

### Dynamic Defaults, Error Checking, Messaging and Dynamic Scaling

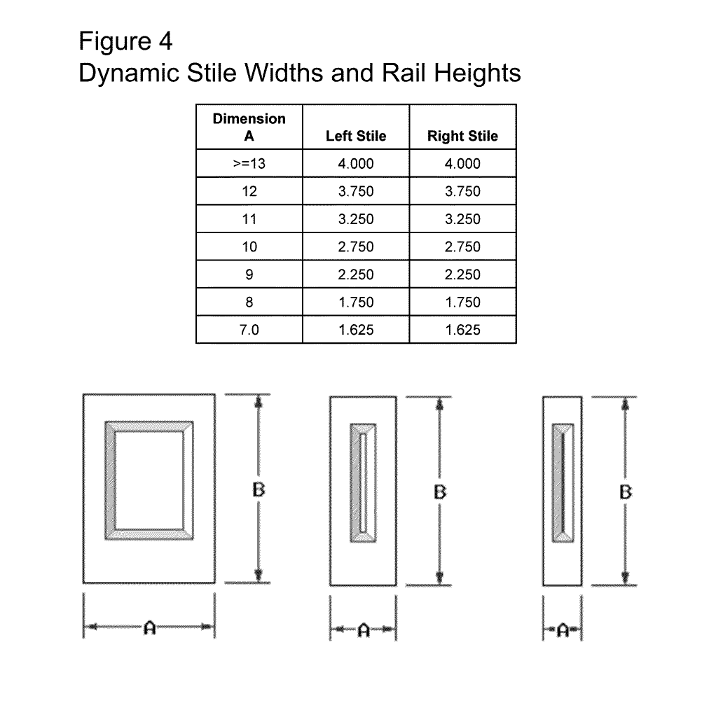

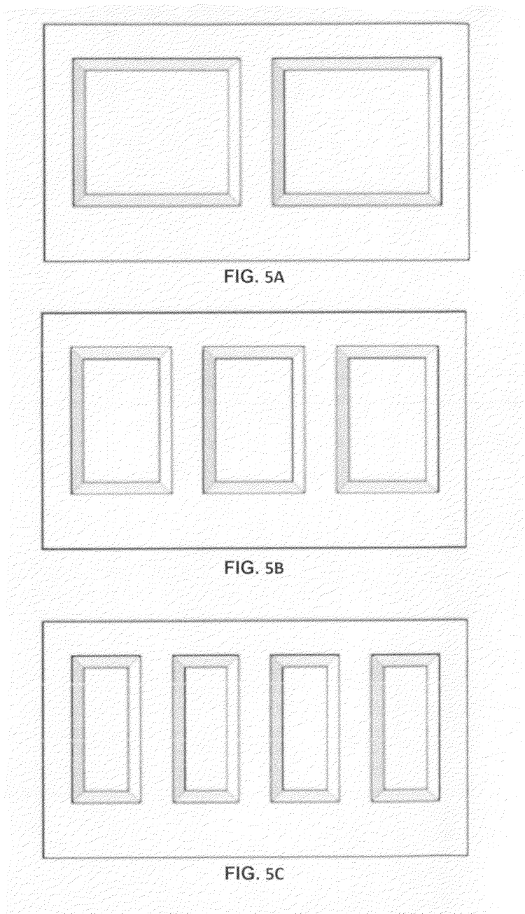

Dynamic Defaults
Default settings are provided when a product is selected. In some instances the defaults are dynamic and will change when inputs change. Two examples of the dynamic defaults are;
   Dynamic Stiles and Rails—When the user reduces the length and or the height to values below 12 inches and 25 inches respectively errors would occur if the stile and rails were static and did not reduce simultaneously. In order to eliminate this common irritating error dynamic stile and rails are incorporated. FIG. 4 shows an example of a dynamic defaults table for the left and right stiles. As the length is reduced below 13 inches the left and right stile defaults also will reduce. In FIG. 4 the panel lengths of 24″, 12″ and 7″ panels will have 4.000 inch, 3.75 inch and 1.625 inch stiles respectively. The top and bottom rails are also dynamic and will also reduce as the height Dimension B is reduced below 25 inches. The user can override the dynamic inputs as necessary as long as they don't violate the system rules.
   Dynamic Inner Panels—The wainscoting quantity of inner panels will increase as the length of the panel increases. The rules for the number of inner panels are based on a ratio of the length of the inner panel to the height of the inner panel. This ratio is a variable that can be altered if necessary.
      The current settings are influenced by the golden ratio, but depending on the aesthetic look of the design other ratios can also be utilized. In FIG. 5 there are 3 wainscoting panels with 2, 3 and 4 inner panels. Each panel is 60 inches long and 34.5 inches tall. The Design System calculates the ratio of inner panel width to the inner panel length and dynamically determines how many inner panels to display.
      The objective of this dynamic selection is to provide the user with an aesthetically pleasing design. The algorithms used to determine the best ratio are based on the golden ratio 1.61803399. Because the inner panel width is a floating variable the system will determine which quantity of inner panels is closest to this ratio.
      The Design System determined that 3 inner panels is the most aesthetically pleasing and set the inner panel quantity to 3.
      There are certain instances when the design warrants wider panels or narrower panels and the user can adjust the quantity of inner panels as desired.

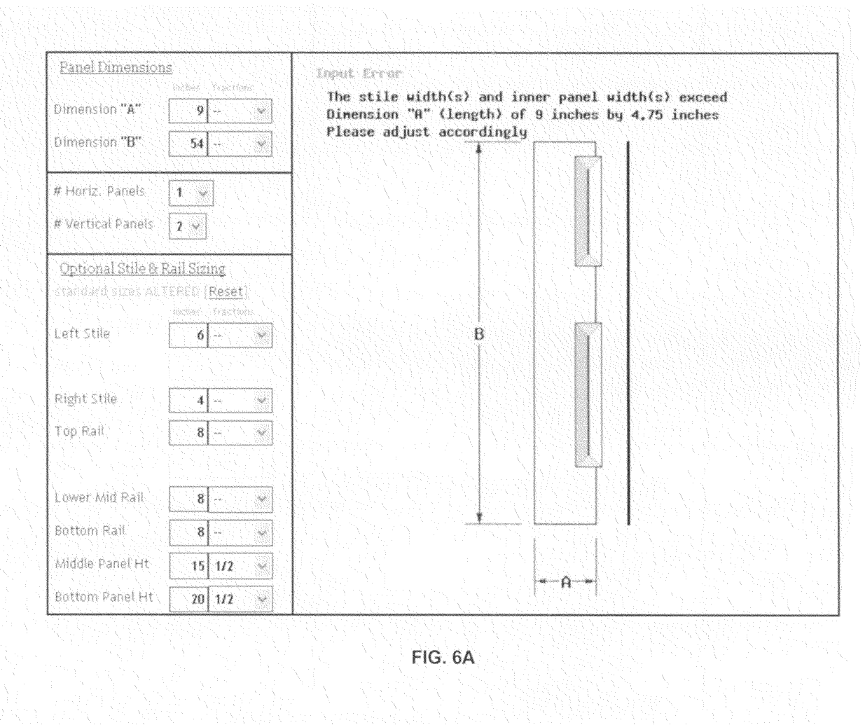

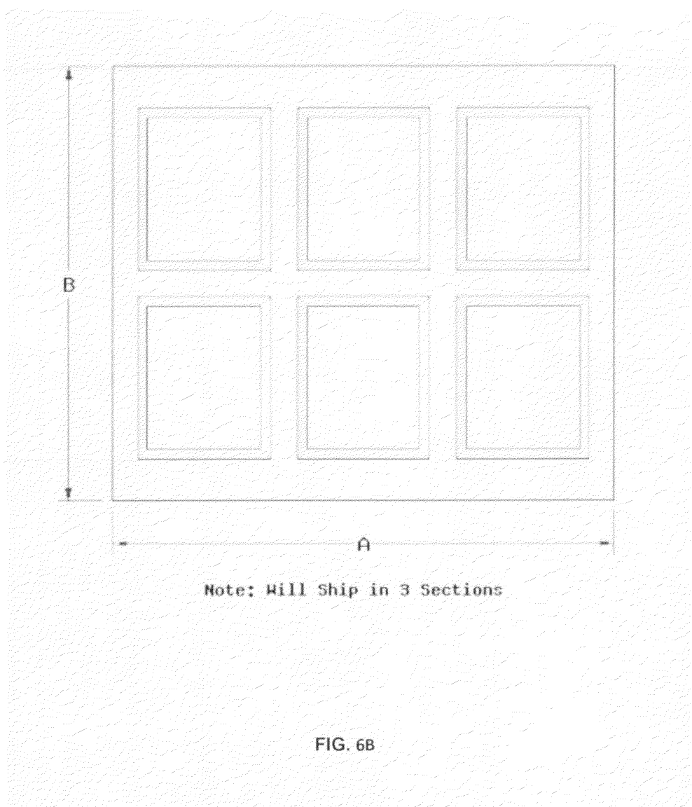

Error Checking and Messaging
There are multiple design and manufacturing rules that are checked every time a user input is changed. The error messaging for these rules are setup in a hierarchical sequence so that only the most relevant messages will be displayed in the user interface. These messages provide insight and guidance to the user so that the error can be resolved. In FIG. 6 the top picture shows an example where the width of the left stile, inner panel and right stile exceed the 9 inch width of the panel. The message quantifies that the error is 4.75 inches and the image of the panel shows that the stack up exceeds the length of dimension A. In FIG. 6 the bottom picture shows a message “Note: Will Ship in 3 Sections” to inform the user that the design will require 3 sheets to fabricate this wall panel.

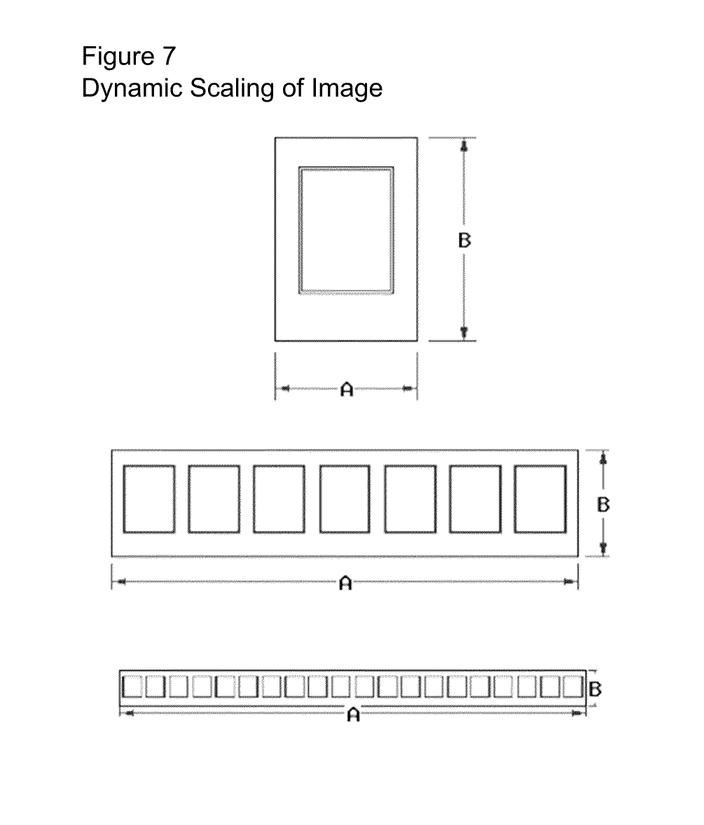

Dynamic Scaling of Image
The image is dynamically scaled to fit within the user interface window. In FIG. 7 the top panel is 24 inches long, the middle panel is 150″ long and the bottom panel is 460 inches long.

### Product Design Images Rendered in Real Time

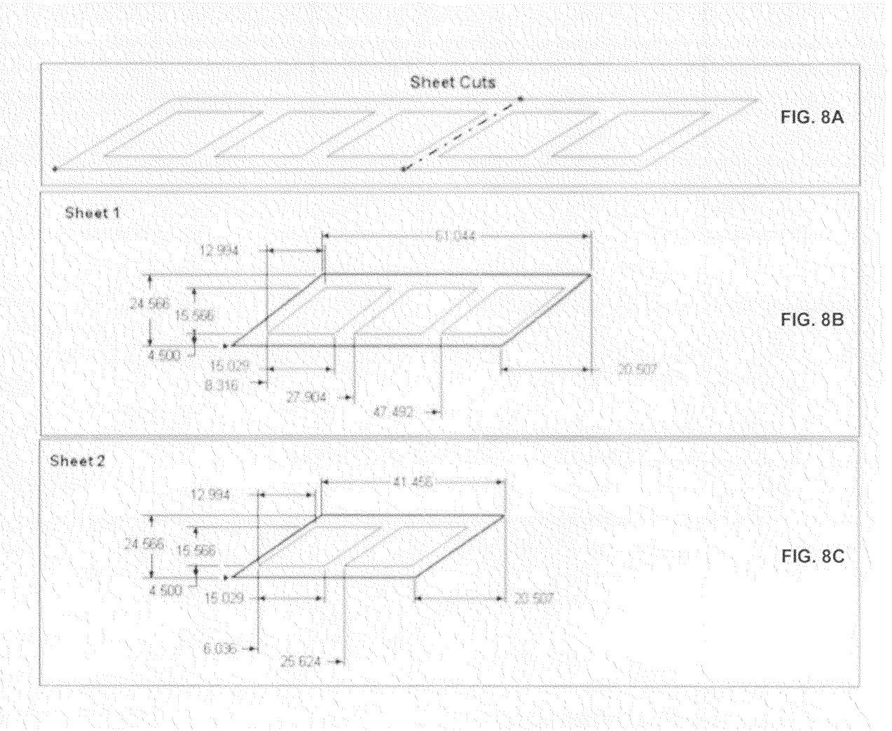

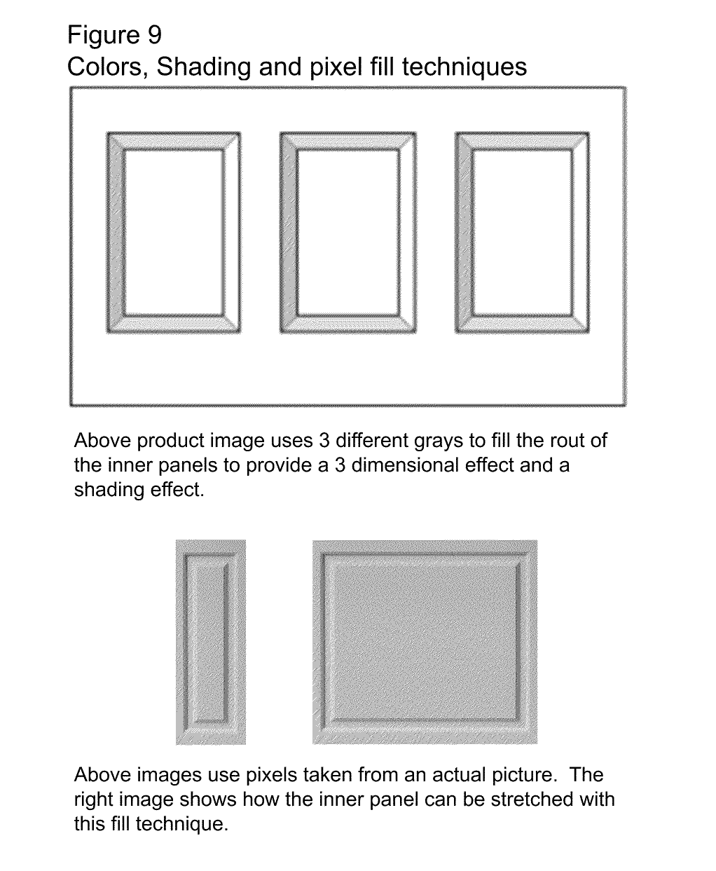

The Product Design Image can be created to represent an architectural drawing of a product. The image can also be enhanced to look like an actual picture by using picture pixel fill techniques.
The image can be generated from any number of software programs. Working models have been developed using Excel scatter plots and enhanced using PHP software. FIG. 8 shows an Excel scatter plot image. In this excel example there is also logic to split the panel along a stile because the total length exceeded the sheet size. Other image generating software programs can also be leveraged to generate the image if so desired. When choosing the software program to generate the product images, there are a number of variables that should be considered. PHP is a good candidate to program in because it runs on an apache server, integrates with MYSQL database software, is responsive, has many advanced features and last but not least is a freeware program.
Colors, Shading and pixel fill techniques can be used where appropriate to enhance the product image to the point that it will look like an actual picture and not an architectural drawing;
   The image components can be colored or shaded to specific colors. In FIG. 9 the upper image has 3 different grays that are used to fill the rout of the inner panels to provide a 3 dimensional effect and a shadowing effect. The left rout is the darkest gray, the top and bottom routes are a medium gray and the right rout is a light gray.
   The image components can be enhanced with pixels taken from pictures to render life like product images. In FIG. 9 the bottom 2 images have been created by taking actual pixels from a wainscoting picture and using these pixels to fill shapes within the product image. The lower right image shows how the size of the panel can be stretched with this fill technique. The symmetry in wainscoting panels make these fill techniques life like because fill segments can be added for each element of the panel, i.e. left rout, right rout, top rout, bottom rout, inner panel, etc.

### Database

The database consists of many tables that are referenced and leveraged by the programs and by the business. A few examples;
   Catalog Table—key product information, pricing, weight, etc.
   Default Table—product default settings for image generation
   Customers Table—demographics for each customer, discounts, type of customer
   Orders Table—contains user ID, status of order, date, cart totals, tax shipping cost, payment type
   Orders Coordinates Table—contains product features and key coordinates.
   Orders Shipped Table—Shipping address for each order
   Rail Dynamic Defaults Table
   Stile Dynamic Defaults Table
   Sales Tax Table
   Saved Products Table—contains input details for each product saved
   Shipping Fees—Table
   Shipping Rates Table
   States Table

### Intuitive User Interface

The user interface can be accessed via the internet or an intranet server. An example of the interface can be seen at http://WainscotingAmerica.com

Design Interface
The design interface provides the user an intuitive design tool. The interface can be altered as appropriate to meet the needs of each product. Key components of the Design interface include;
   Product icons to select desired product
   Input fields with drop downs for fractions and inner panels
   Real Time Product Image with messaging
   Pricing and unit prices
   Navigational buttons to save, view cart, delete panel and create a new panel
   Line Item Tabs

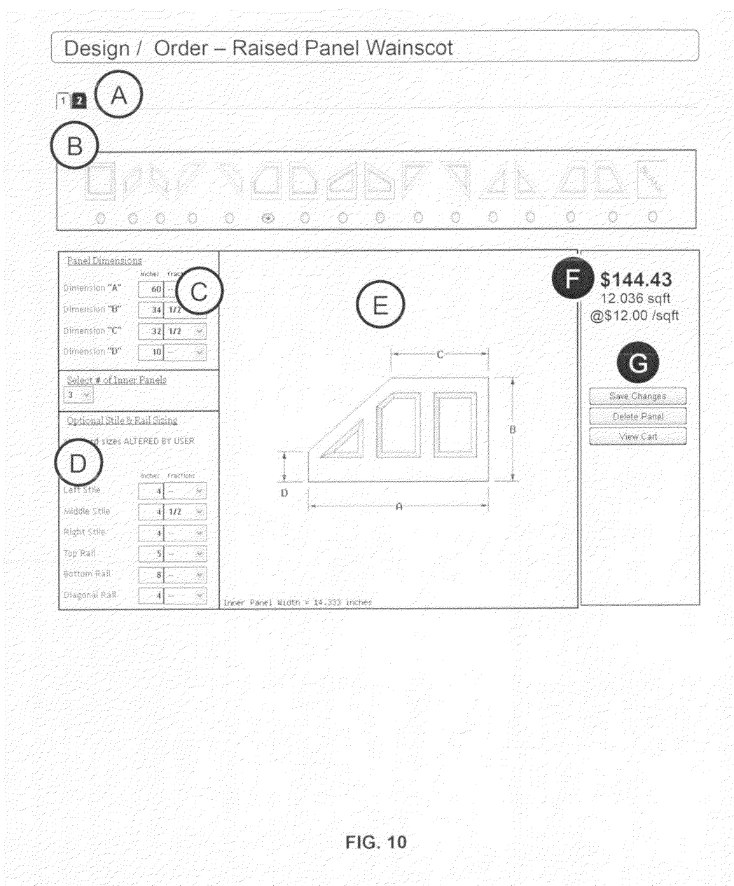

See FIG. 10 for the design interface details;
A. Panel Line Items. These tabs can be selected to navigate to other panels.
B. Select the product shape to start the design process
C. The outside dimensions can be altered with drop downs for the fractions and inner panels
D. Default Stiles and Rails can be adjusted if necessary
E. Product Image Window. Will display product image, notes and error messages.
F. Pricing and unit prices will update as inputs are altered
G. Navigation buttons to save, view cart, delete panel and create a new panel.

Cart with Architectural Specifications
Clicking on the view cart link will navigate to user to the cart. All saved products will be displayed in the cart. An image of the product that also includes a mouse over feature to enlarge the product image and all critical design inputs will be displayed, along with the price of the product.
The total weight of the saved products will be displayed at the bottom of the order.
The total price, discount (if applicable) S&H (shipping and handling), Tax and Total pricing will be detailed at the bottom of the cart.
Print Cart and Check Out and PayPal buttons.

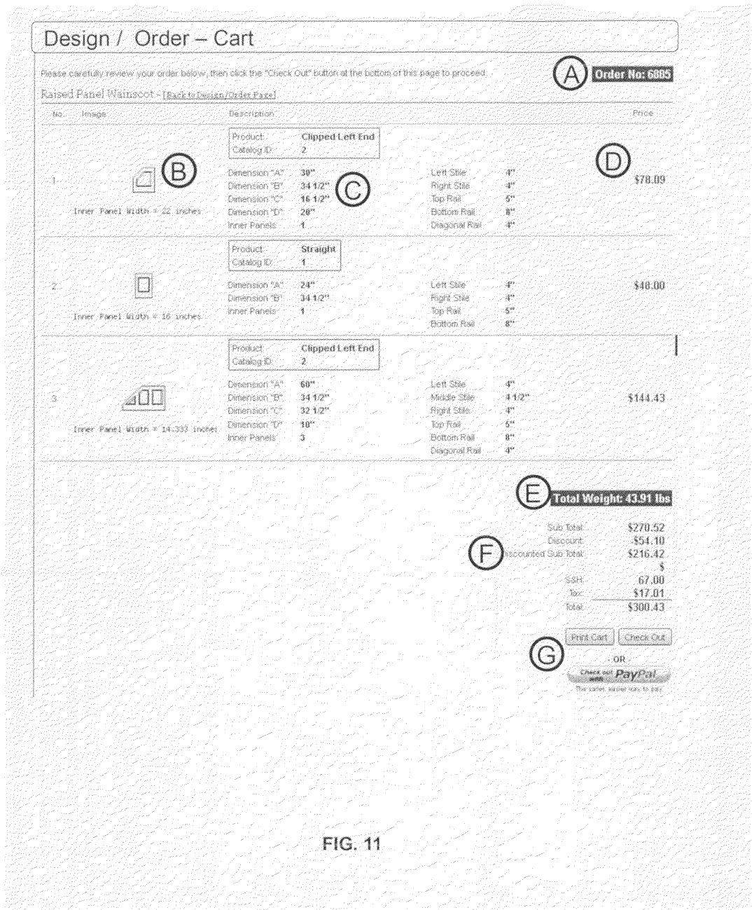

See FIG. 11 for the Cart items
A. Order number
B. Product Image that has a mouse over capability to enlarge
C. User inputs are documented for review
D. List price of each panel
E. Total Weight of products
F. Pricing; sub total, discount, S&H, Tax and total pricing
G. Navigation buttons to print cart, check out or pay with PayPal.

Check Out and Payment Process
The project name field is available to enter pertinent information
Billing/Contact information includes name, address, phone numbers, email address
Passwords can be changed is so desired with a confirm process field
Shipping Information includes
   Pickup is an option than can be turned on for local customers
   Shipping to billing address
   Shipping to different address
   Special Delivery needs such as Residential Delivery, Construction site, Business selections can be setup with additional fees
   Notification prior to delivery can be selected for an additional fee.
Payment options include PayPal, Visa, Master Card, Discover and American Express
Approved clients will also have the ability to have there orders billed

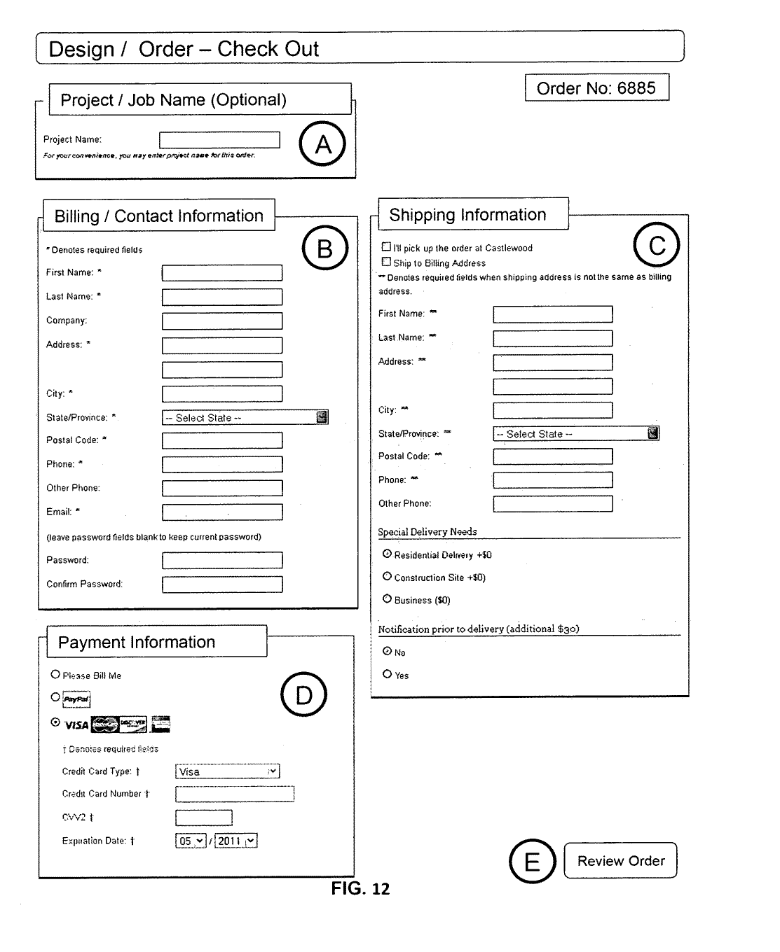

See FIG. 12 for the Checkout and Payment Process items
A. Project Name
B. Billing Information
C. Shipping options and Shipping Address
D. Payment Options
E. Review Order Navigation Button

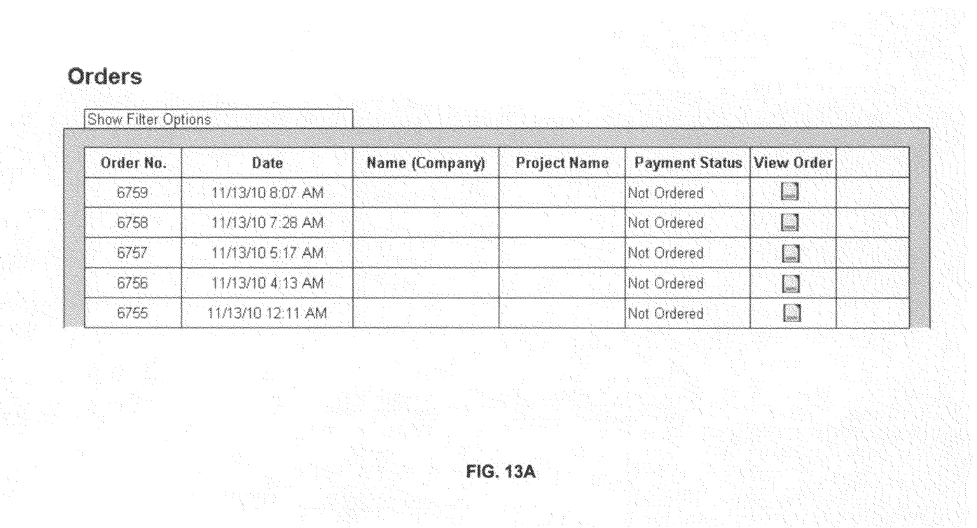

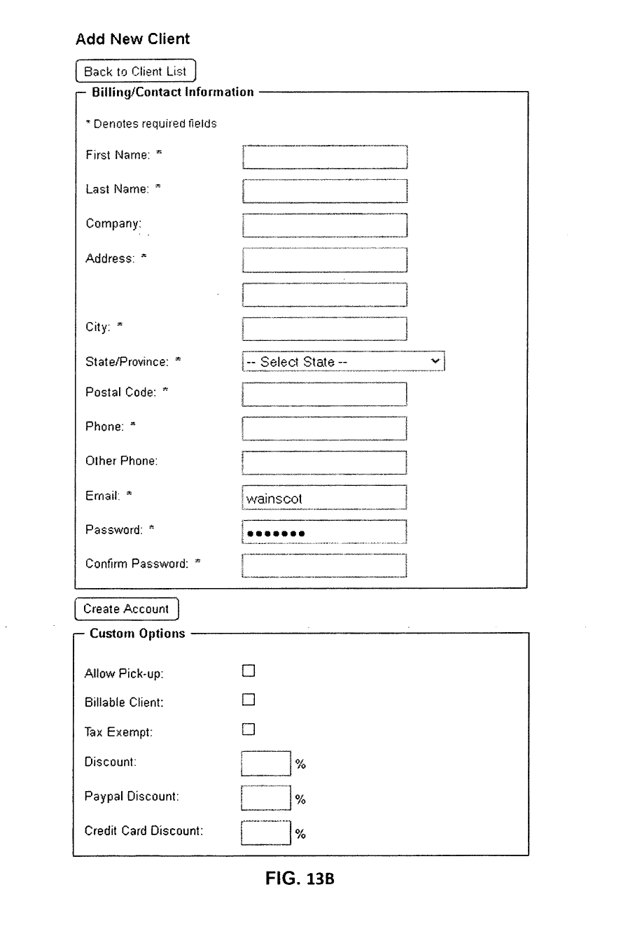

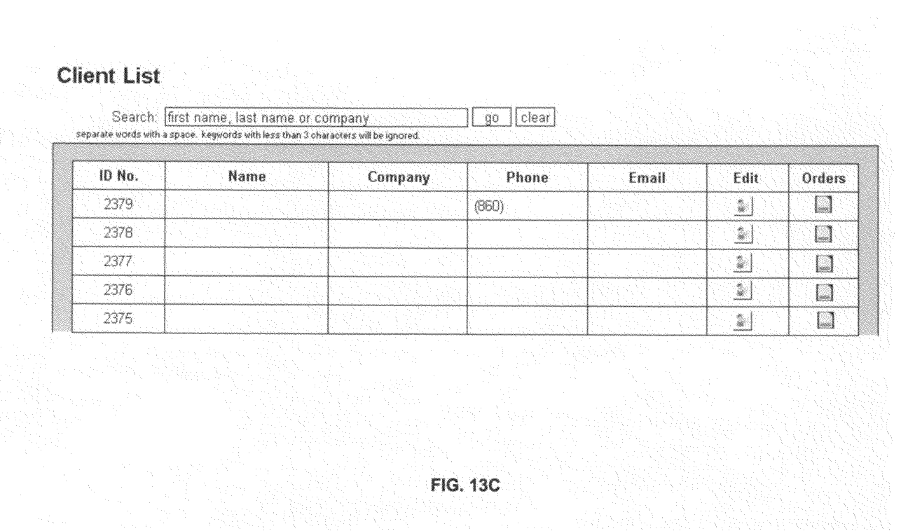

Business Interface Views—FIG. 13
The business can access many tables and can control many attributes of the business including but not limited to the following;
   Order page with date, Customer Name, Project name, payment status
   Order viewing capability. Can view customer orders that are in process simultaneously with the customer so that we can assist them through the design process.
   Panel Coordinates page allows programmers to see key coordinates of product.
   Add new clients—add demographics, setup discounts, shipping categories, payment options
   Client list view

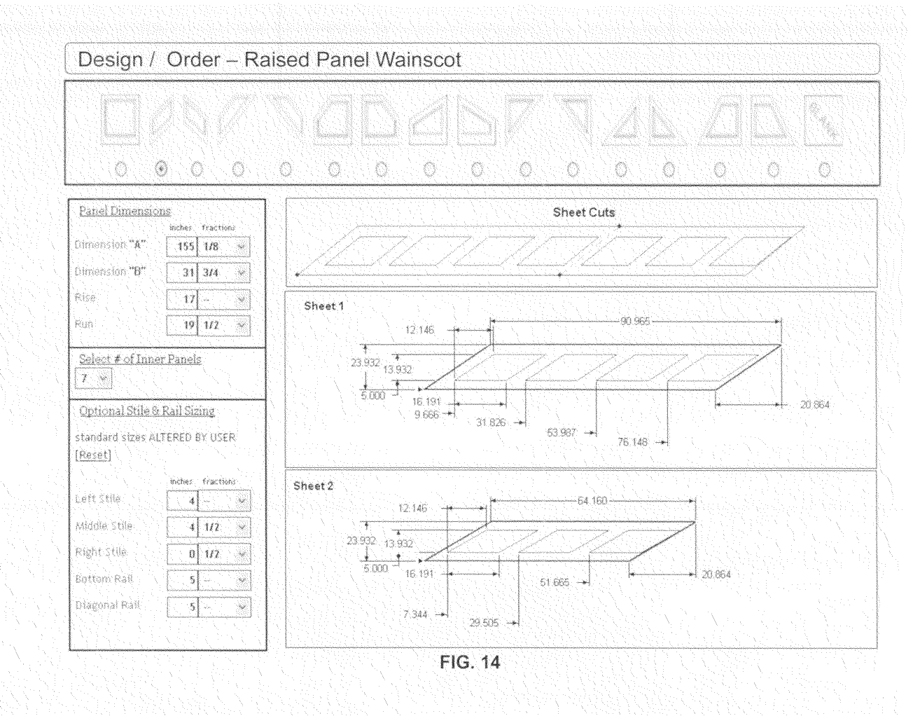

### CNC Programming Information and Coordinates—FIG. 14

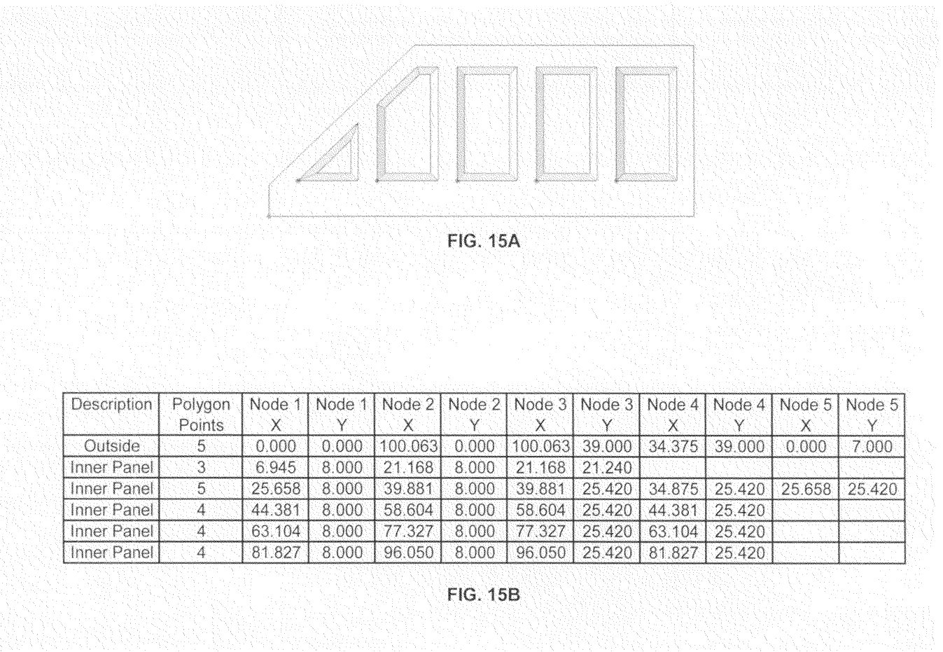

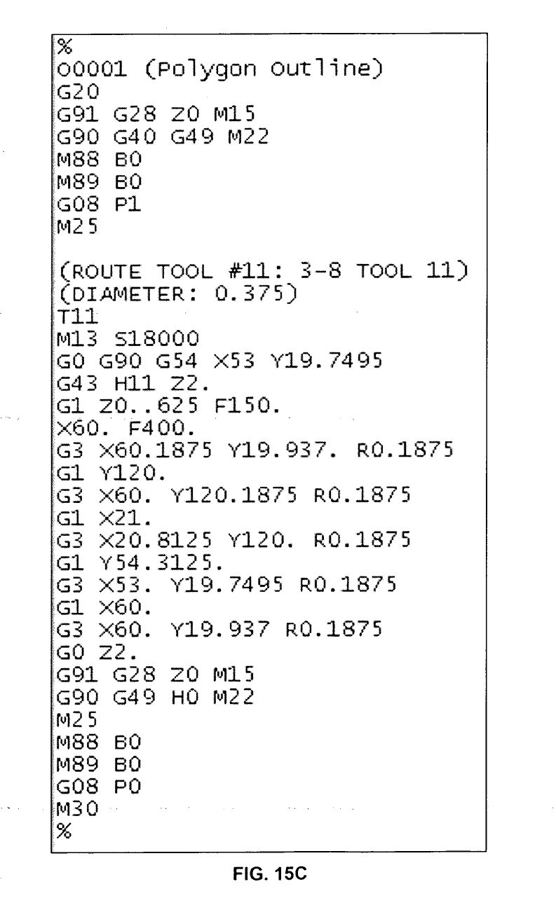

In addition to generating an image of the product the system also calculates key dimensional information that is saved in a table to be leveraged for CNC machine programming.
Programming parameters also take into account the machine capabilities such as max length and max width and will split products as necessary.
Programming parameters will also rotate product designs to optimize material use. An example of this is a staircase panel in FIG. 14. In this example 3½ sheets would have been required if the panel was not rotated flat and would have been fabricated in 7 sections verses 2 sections when rotated flat.
Visual Basic is used to write the machine code programs for the CNC machine. The Visual Basic references a coordinates table that is created by the Design System. In FIG. 15 the critical nodes for the wainscoting panel are calculated in the Design System and saved to the coordinates table. The machine code is also generated using a visual basic program that is linked to the coordinates table.

### Additional Features Relevant by Product Type

### Wainscoting Panel Example

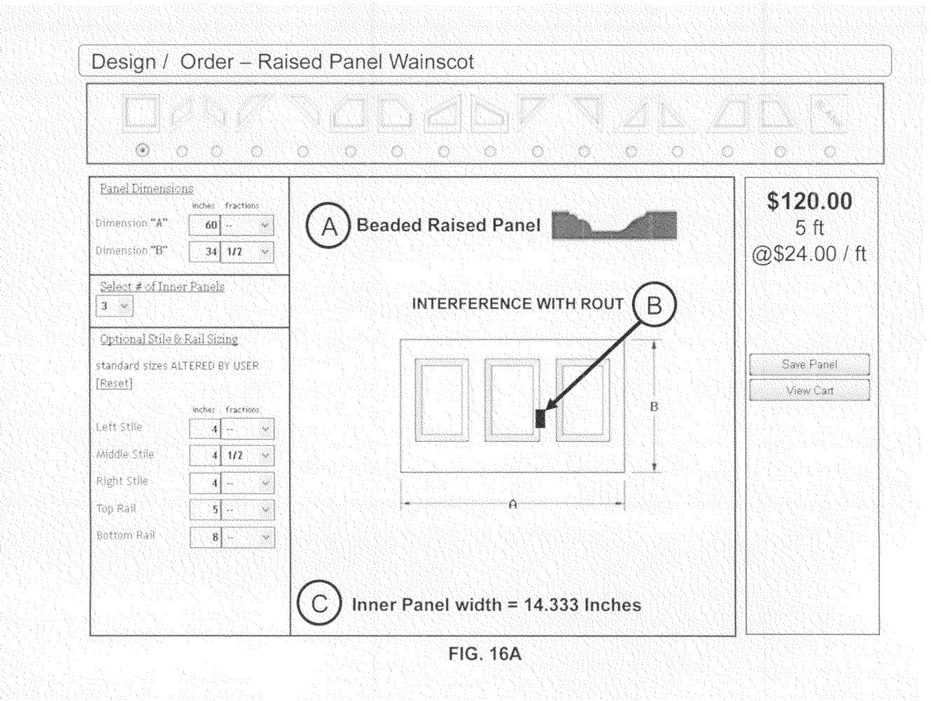

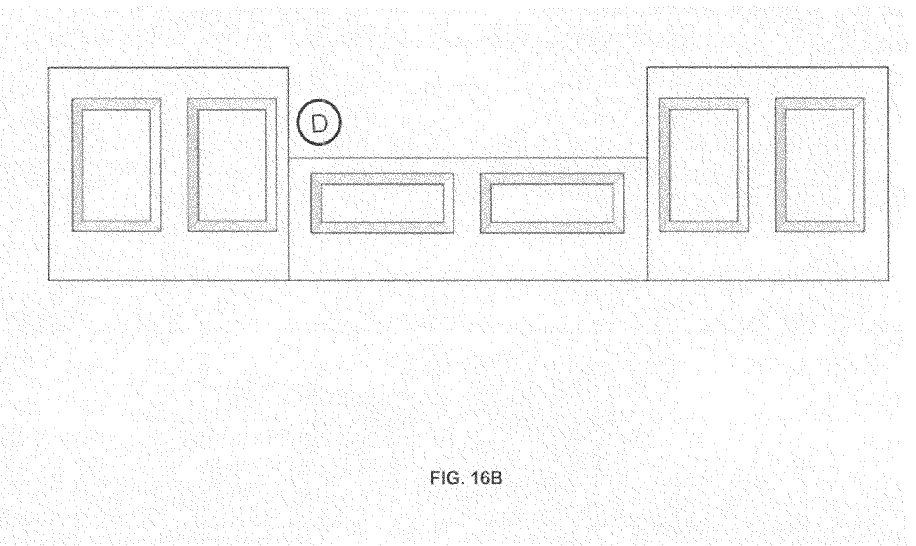

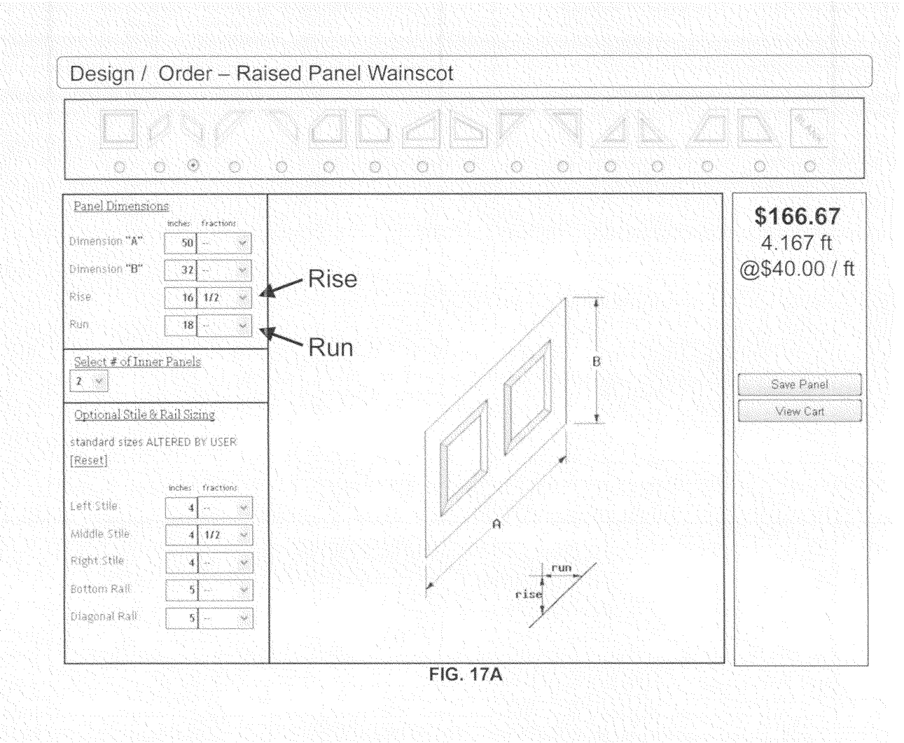

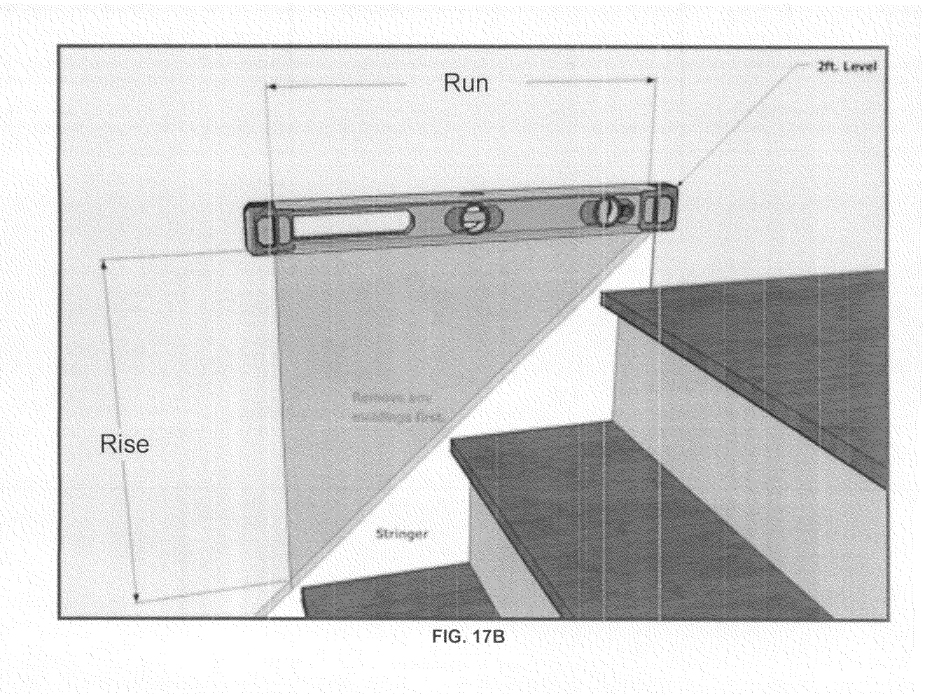

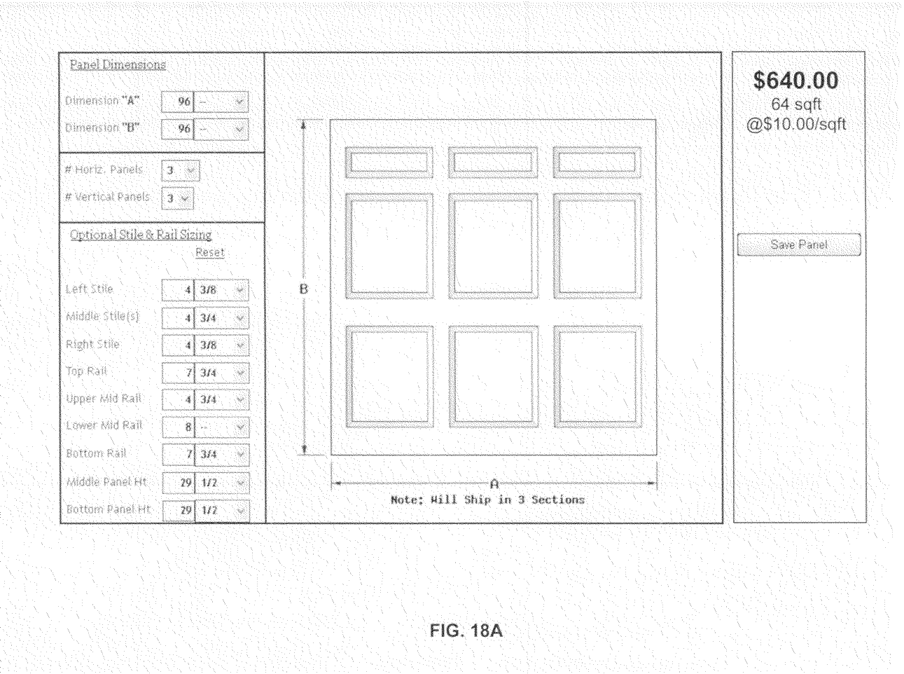

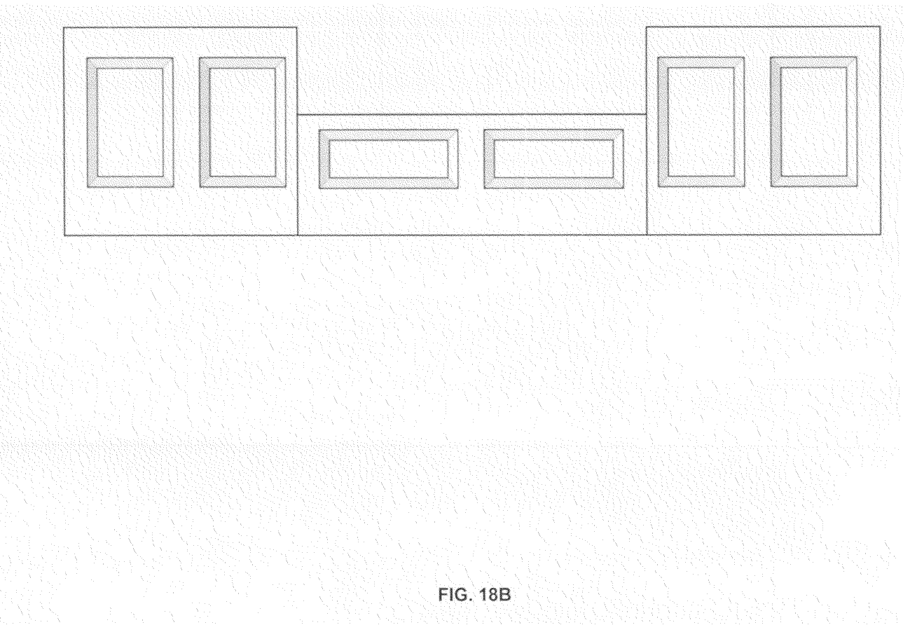

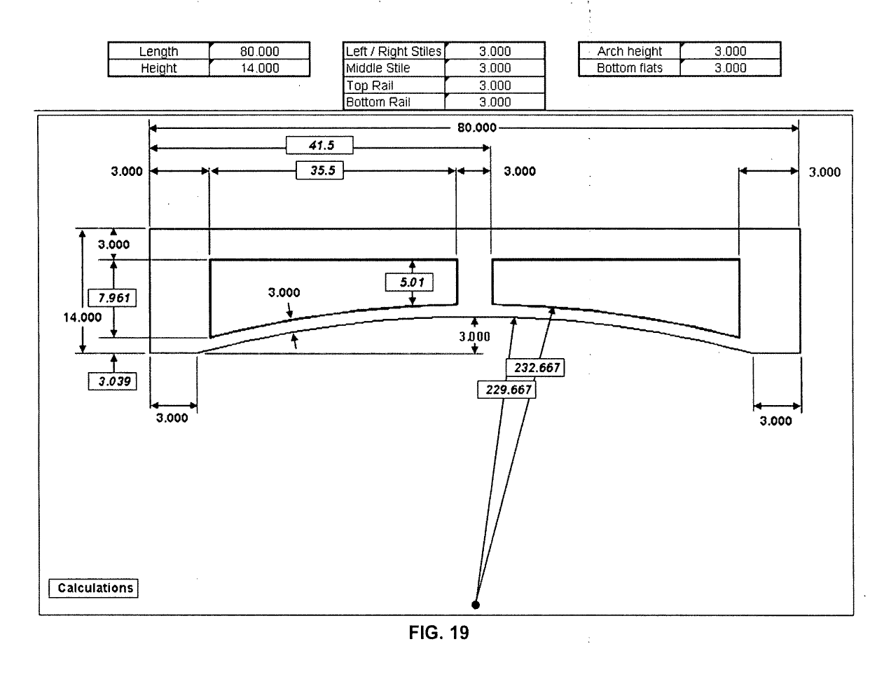

Wainscoting straight or clipped panel—Refer to FIG. 16 for additional wainscoting features detailed below;
   A. There are currently 6 wainscoting profile panel designs. The design cross section can be displayed in the product image window.
   B. The system can also check for the location of outlet and vents to see if they interfere with the inner panels and will display a note “Interference with rout” message.
   C. The inner panel width is not a user input for most wainscoting designs. The design tool can display the actual width of the inner panel so that the user can compare panels and adjust for uniformity.
   D. Integration of individual panels into a wall configuration. This allows users to visualize their design with panels stacked together. Also capability to add windows and doors into the stacked configuration.
Staircase Wainscoting Panels—Refer to FIG. 17 for details of the design tool and rise and run measuring process.
   The complexities with staircase panels have been greatly simplified with the design interface because rise and run input fields are all that is required to calculate the angle of the staircase stringer.
   Developed a measuring process that works in conjunction with the Staircase design tool. A 2 foot level rise and run measurement process—unique in that when combined with staircase design interface tool users can measure staircase panels with ease and precision.
      1. Place one end of a 2 foot level on the stringer and draw a horizontal line on the sheet rock.
      2. Go to the end of line and hold the level vertical (plumb) and draw a vertical line back to the stringer.
      3. Measure the lengths from the intersections back to the stringer. The vertical line length is the “Rise” and the horizontal line length is the “Run”
      4. Enter the Rise and Run values into the Staircase Design Interface
      Note: The level length does not need to be limited to a 2 foot level however the 2 foot length has been chosen because most do it yourself homeowners and professional craftsmen have a 2 foot level. The accuracy of the staircase angle using a 2 foot level is usually to the 1 tenth of a degree (0.X degrees) which is a magnitude better than choosing a whole number angle.
Full Wall Wainscoting panels—FIG. 18
   Similar to standard and clipped wainscoting panel with the additional feature of adding stacked inner panels and the ability to control the size of the inner panels. If two or more inner panels are stacked the top most inner panel usually floats in height.
   Wall panels can also incorporate multiple panels stacked together to give the user the ability to view the entire wall.
Arched Wainscoting Panels—FIG. 19
   The Design System significantly reduces the complexities for designing arched panels by calculating all geometric coordinates. The user only needs to enter a few easy to measure dimensions.
   The Design System will solve for difficult unknowns such as the radii of the arches and the locations of all inner panel edges.
      Pediment Head with Pilaster Window and Doorway Millwork
The Pediment Head with Pilasters millwork design interface allows the user to choose the product type, the jamb to jamb width of the window or door and the width of the pilaster millwork.
This product image is totally dynamic in that every line and curve is mathematically derived and drawn.

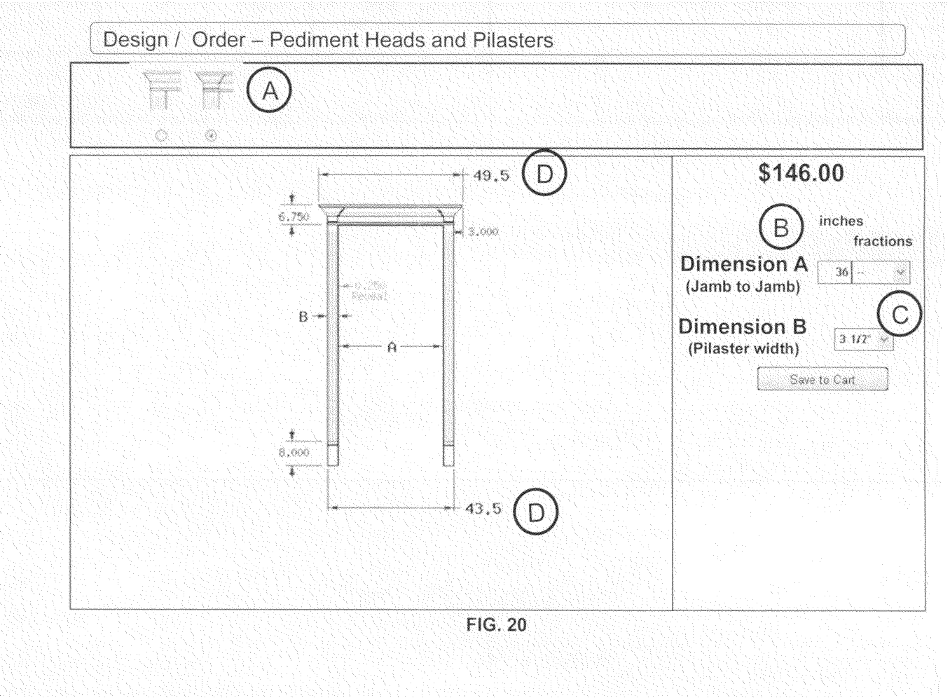

Refer to FIG. 20 for details of the Pediment Head with Pilaster design tool;
A. The Pediment Head and Pilasters are available in 2 common styles that the user can choose from.
   B. The width of the Pediment Head is determined using the jamb to jamb width dimension.
   C. The width of the fluted pilasters can be selected from a drop down field. There are 3 sizes currently available.
   D. The widths of the Pediment head and Breast board are also displayed on the image. These dimensions are used by the manufacturer as instructions for the shop personnel.

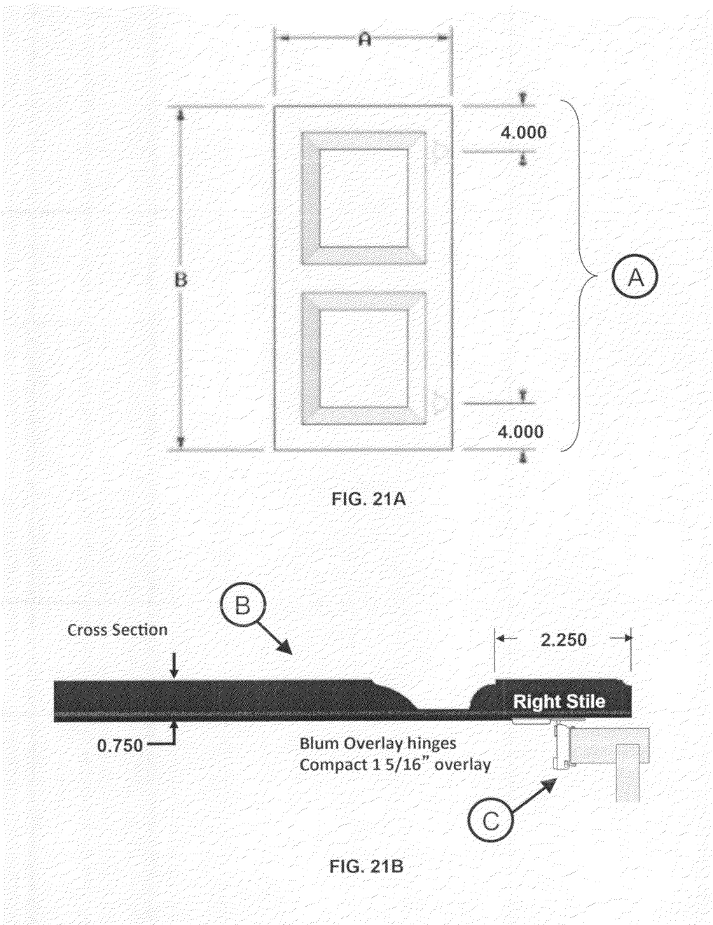

### Cabinet Doors and Drawer Fronts—FIG. 21

The Cabinet door and drawer front design interface simplifies door designs and allows customers to choose key attributes and design doors quickly.
Similar to the wainscoting process however there are additional options that are available in the design interface for doors such as outer edge profile, boring and hinge options.

Refer to FIG. 21 for details of the Cabinet Doors and Drawer Fronts Product Image
A. Cabinet doors are dynamically drawn just like the wainscoting panels. If the hinge boring option is selected by the user the dimensions of the hinges will be displayed. The dimensions for the hinge boring are dependent on the size of the door and will adjust in real time.
B. The cross section of the door and the outside door edge profile will be displayed.
C. If the user selects hinges the hinge style will be displayed. In the above configuration overlay hinges are being displayed.

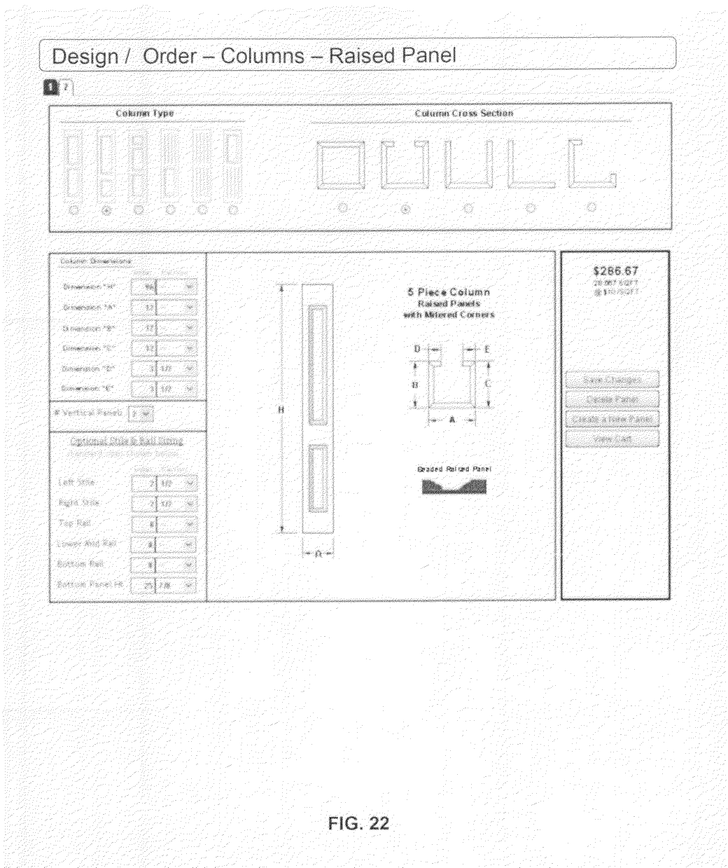

### Columns—FIG. 22

The Column Design System works similar to the wainscoting panel Design System in that each side of the column is very similar to a wainscoting panel. The column design tool allows users to choose the column type, the cross section which specifies the number of column sides and the mitering configuration of these column sides. The width of each side can be configured independently.

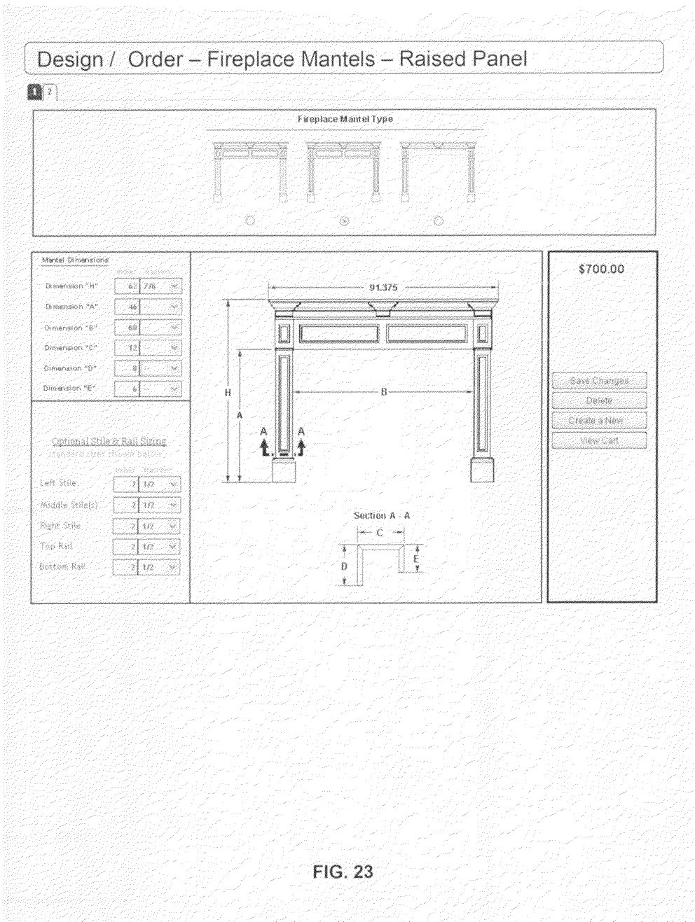

### Fireplace Mantels—FIG. 23

The user chooses the type of mantel that they want to design. Some of the features include fluted pilaster columns verse raise panel columns and or an arched breast board. Depending on the design inputs other options will also be presented as options, i.e. if the column widths are narrow the user will be able to choose recessed or shaker stile inner panels.
There are 6 key design inputs that accommodate most mantel configurations.

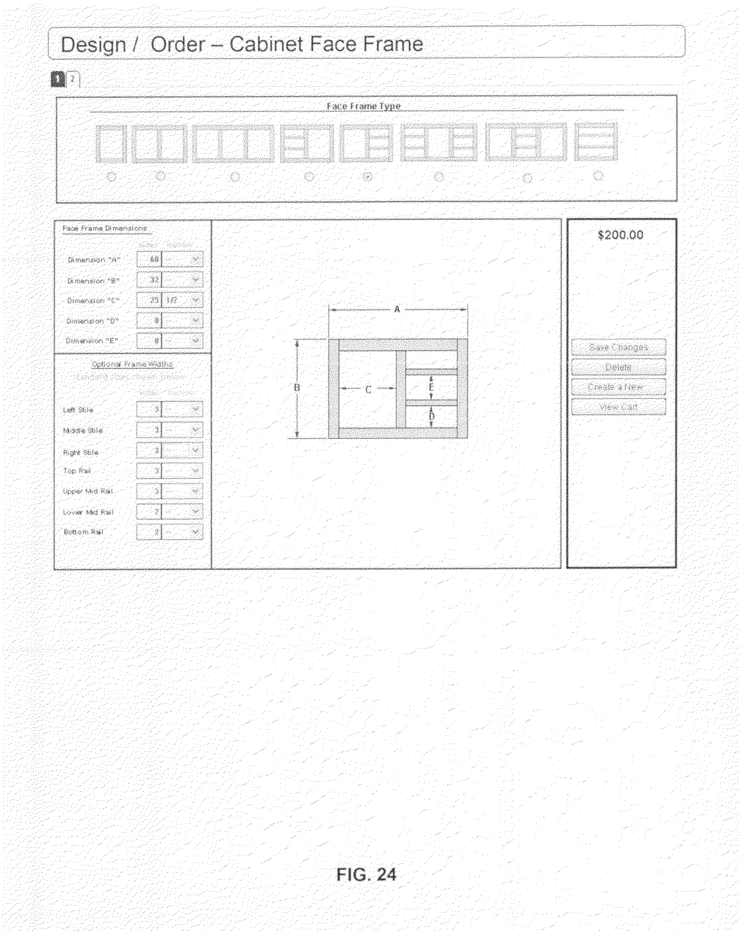

### Cabinet Face Frames—FIG. 24

The cabinet face frame design tool currently has 8 face frame configuration types to choose from. These are the most common configurations. Additional types can be added if the demand warrants. Once the customer chooses the face frame type the user input window will be displayed with the appropriate inputs. There are 2 sections to the inputs window. The Face Frame Dimensions section has the outside dimensions and the inside opening dimensions. The tool will float one inside width and one inside height to avoid double dimensioning. The “Optional Frame Widths” section has standard 3″ default widths for the outside rails and all stiles and uses a standard 2″ width default for the inside drawer rails. The user can override these widths as necessary.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

Wherefore we claim:

1. A system for online internet ordering and processing of architectural products comprising:
a user interface having a visual display for presenting information, and an input device to receive optional user inputs;
an electronic network for communication;
a server in communication with said user interface over the electronic network for finalizing an order;
manufacturing and shipping equipment for producing and shipping the order;
wherein said server generates images in response to user inputs in real-time;
creates and maintains a checkout cart for the user session; generates and processes a payment transaction with the user; terminates the user session in a finalized order;
transmits the order to manufacturing equipment and personnel; and said manufacturing equipment producing and shipping a product in conformance with said order to said user.

2. A method for online internet ordering, processing and manufacturing of architectural products comprising the steps of:
a user interacting with a visual display to selectably configure and finalize an order for an architectural product;
said visual display presenting real-time visual feedback to the user as the user changes input parameters of his order;
finalizing the order and communicating the order to a manufacturing facility;
manufacturing the order; and
shipping the order to the user.
